(19) United States
(12) Patent Application Publication
(10) Pub. No.: US 2019/0070861 A1
(43) Pub. Date: Mar. 7, 2019

(54) DIRECT PRINTING MACHINE AND METHOD FOR PRINTING CONTAINERS WITH DIRECT PRINTING

(71) Applicant: KRONES AG, Neutraubling (DE)

(72) Inventors: Johannes REGENSBURGER, Barbing (DE); Eduard HANDSCHUH, Donaustauf (DE); Martin WAGNER, Regensburg (DE); Viktor GETTE, Wörth (DE)

(21) Appl. No.: 16/120,976

(22) Filed: Sep. 4, 2018

(30) Foreign Application Priority Data
Sep. 4, 2017 (DE) 10 2017 215 475.6

(51) Int. Cl. B41J 2/175

(52) U.S. Cl. CPC B41J 2/17596

(57) ABSTRACT

A direct printing machine for printing containers with a direct print, having at least one stationary direct printing station with a direct print head, an ink supply system for supplying ink to the direct print head, and with a conveyor for conveying the containers past at the direct printing station, the ink supply system comprising a supply line and/or a return line for the printing ink, for producing ink flow from a supply tank to the direct print head and/or back, wherein the ink supply system comprises at least one header tank arranged in the supply line and/or the return line for setting a meniscus pressure of the printing ink, and a valve terminal is arranged between the header tank and the direct print head to interrupt the ink flow over the direct print head and to produce it in a bypass line.

### CROSS REFERENCE TO RELATED APPLICATION

This application claims priority to German Patent Application No. 10 2017 215 475.6 entitled “DIRECT PRINTING MACHINE AND METHOD FOR PRINTING CONTAINERS WITH DIRECT PRINTING,” filed on Sep. 4, 2017, the entire contents of which is hereby incorporated by reference in its entirety for all purposes.

### TECHNICAL FIELD

The present disclosure relates to a direct printing machine and a direct printing method for printing containers with direct printing.

### BACKGROUND AND SUMMARY

Usually containers, such as beverage containers, are provided with a label in a labelling machine to identify the contents of the container and/or for advertising purposes.

Recently, however, direct printing machines and methods are increasingly being applied, whereby, instead of or in addition to the labels, the containers are provided with direct printing according to the ink jet principle. This makes it possible to print the containers individually in a stream of containers.

Such direct printing machines usually comprise at least one stationary direct printing station with a direct print head and a conveyor for conveying the containers past the at least one direct printing station. With the conveyor, for example, the containers are picked up and conveyed to the at least one stationary direct printing station. There, the containers are rotated by means of the container receptacles, and in the process, printed with printing ink using the direct print head from a plurality of print nozzles. The print nozzles are controlled in such a way that the dispensed ink drops produce the desired printed image on the containers. If multicolor direct printing is desired, the containers are conveyed past several direct printing stations, where they are sequentially printed with printing inks of different colors. Furthermore, such direct printing machines include an ink supply system with a port for the printing ink to produce an ink flow from a supply tank to the direct print head. For inks having higher pigmentation, the ink supply system optionally includes a return line for producing ink flow from the direct print head back to the supply tank. As a result, the printing ink is kept in a continuous flow, thereby preventing particles from settling in the printing ink.

DE 10 2013 217 679 A1 discloses a printing machine for ink jet printing on containers, comprising at least one stationary printing unit for printing on containers and one filling station designated to the printing unit for the printing ink.

DE 10 2009 020 702 A1 discloses a printing system for printing on bottles, with a print head that can be moved along a conveying path for the containers and works according to the ink jet principle for printing on the respective container arranged at a printing position, and with a supply system for the print head with printing ink. Since the print head moves with the bottle to be printed, it is proposed to divide the supply system into a static part and a moving part, whereby the moving part has an auxiliary tank for the ink, in addition to the print head, for ensuring high print quality.

The disadvantage thereby is that with the maintenance of the direct print head or during the startup, the supply line and/or return line of the ink supply system must be disconnected; such a process proves to be time-consuming when subsequently restoring a closed ink flow. In addition, automatic rinsing of the ink supply system or the direct print head is not possible.

The object of this present disclosure is therefore to provide an ink supply system for a direct printing machine with at least one stationary direct printing station and one conveyor, which simplifies the production of a closed ink flow and enables automated rinsing of the ink supply system or the direct print head. The present disclosure also aims to reduce the number of ink pumps without compromising print quality.

To solve this problem, the present disclosure provides a direct printing machine for printing containers with direct printing, with at least one stationary direct printing station with a direct print head for printing the containers with the direct printing, an ink supply system for supplying the direct print head with printing ink from a supply tank, and with a conveyor for conveyance of the containers past the at least one stationary direct printing station, the ink supply system comprising a supply line and/or a return line for the printing ink to produce an ink flow from the supply tank to the direct print head and/or back, wherein the ink supply system comprises at least one header tank arranged in the supply line and/or return line for setting a meniscus pressure of the printing ink towards the direct print head, and in that a valve terminal is arranged between the at least one header tank and the direct print head in order to interrupt the ink flow via the direct print head and to produce it in a bypass line parallel to the direct print head. Advantageous embodiments of the present disclosure are described in the subclaims.

The fact that the ink supply system comprises the at least one header tank arranged in the feed and/or return, a pre-defined meniscus pressure of the printing ink can be precisely adjusted at the direct print head and the circulation can be controlled so that the print result has particularly high quality.

By placing the valve terminal between the at least one header tank and the direct print head, the flow of the printing ink can be switched either through the direct print head or via the bypass line. This makes it possible to automatically rinse the ink supply system with printing ink during maintenance or startup as well as to remove bubbles or foreign matter from it. In addition, it is possible to open the valves in the valve terminal intermittently and thus carry out purge (shock cleaning) with increased pressure. This makes the direct print head particularly easy to clean independently of other direct print heads connected to the ink supply system. For example, the air and/or air bubbles can be removed from the pressure system.

Consequently, with the inventive direct printing machine, it is possible to achieve high-quality direct printing at lower acquisition or purchasing costs for the ink supply.

The direct printing machine can be arranged in a beverage processing station. The direct printing machine can be arranged downstream of a filling station for filling a product into the containers and/or a capper for sealing the containers with closures. However, the direct printing machine can also be connected upstream of the filling process and/or be connected directly downstream of a container production process. When detached from this, it can also be a direct printing machine that is not assigned to any equipment, but operates in the so-called stand-alone mode.

The containers can be designed to hold beverages, hygiene products, pastes as well as chemical, biological and/or pharmaceutical products. Generally, the containers can be provided for any flowable or fillable media. The containers can be made of plastic, glass and/or metal; however, hybrid containers with material mixtures are also conceivable. The containers can be bottles, cans, beverage containers and/or tubes. It is conceivable that the containers are shaped or molded containers which deviate from rotational symmetry.

The conveyor can comprise a carousel and/or container receptacles arranged in a rotating or revolving manner. Thus, the containers can be conveyed in a predetermined pattern and rotated relative to the printing stations. The conveyor can be designed to convey the containers intermittently. During printing, the conveyance of the containers is briefly stalled opposite the at least one stationary direct printing station and afterwards the conveyance continues. It is also conceivable to design the conveyor to continuously convey the bottles, when dealing with specially molded containers, for example.

The at least one stationary direct printing station can comprise at least one further direct print head, each with one further valve terminal, and each with at least one further header tank. A distributor unit can optionally be arranged after the supply tank, so as to distribute the printing ink to the direct print head and to the at least one further direct print head, optionally over the header tank and the at least one further header tank and/or over the valve terminal and the at least one further valve terminal. In this way, the direct print heads can be supplied with the printing ink of one color from the same supply tank. In other words, the stationary direct printing station can also comprise a plurality of the aforementioned direct print heads or direct print heads for simultaneously printing each of the containers with a plurality of direct print heads, whereby the ink supply system is designed to supply the direct print heads from the supply tank, wherein the ink supply system comprises the distributor unit and therefrom, for each of the direct print heads, a supply line and a return line for the printing ink are provided to produce an ink flow from the supply tank to the direct print heads and back. By using the distributor unit between the at least one header tank and the direct print head, the ink supply system can supply a variety of direct print heads. The use of cost-intensive ink pumps is thus reduced to a minimum. By using several direct print heads, the pressure range at the containers can be increased. The ink supply system may comprise, per direct print head, at least one header tank arranged in the supply and/or in the return for setting a meniscus pressure of the printing ink towards the respective direct print head, and wherein a valve terminal is arranged between the header tank and the direct print head in both supply and return to interrupt the flow of ink across the respective direct print head and to produce it in an associated bypass line parallel to the respective direct print head. The valve terminals can be designed to be individually switchable. Thus, the supply lines or the direct print heads can be rinsed individually.

In addition, the header tank can optionally include a heating device, with which better viscosity or a better ink temperature control can be achieved.

The direct print head can operate with a digital or ink jet printing process, in which the ink is supplied to the containers via a variety of printing nozzles. Here “ink jet printing process” can mean that in the chambers of a print nozzle, a sudden pressure increase via piezo or thermocouples is generated in such a way that a small amount of print fluid is forced through the print nozzle and discharged in the form of print drops to the container. Each of the direct print heads can have a number of print nozzles within a range of 100 to 10,000, especially in a range of 500 to 5,000 nozzles. The print nozzles can be arranged in one or more rows of nozzles (for example, 1 to 4), which are arranged particularly parallel to the container axis. The direct print head can include a supply port and/or a return port to supply or discharge the ink to the direct print head. The supply line can be connected to the supply port and the return line can be connected to the return port of the direct print head.

The direct printing machine may include or be connected to a control unit for controlling the direct print head and/or the conveyor, optionally the container receptacles and/or the ink supply system that cooperate with or are connected thereto. The control unit can include a CPU, a monitor and/or an input unit.

The ink supply system can include an ink pump in the supply and/or return lines to produce the ink flow. The ink pump may include a pressure relief valve in the supply line to prevent pressure peaks in the flow. The ink supply system can include the distribution unit for distributing the ink from the supply tank to the direct print head and one or more further direct print heads. Optionally, the distribution unit can include a plurality of controllable switching valves in the supply and return lines respectively to control ink flow to the respective direct print heads.

The valve terminal may be arranged in the supply line and/or in the return line. It is also conceivable that the valve terminal is connected to a supply port and/or return port of the direct print head.

The valve terminal can include a switchable flow valve, a switchable return valve and a switchable bypass valve in the bypass line. In this way, the supply and return lines of the direct print head can be interrupted, and the bypass line can be released or unblocked to interrupt the ink flow across the direct print head, producing it parallel to the direct print head in the bypass line. Thereby, a dynamic pressure can be built up in the supply and/or return lines for the purge. Subsequently, the supply line and/or the return line of the direct print head are released again by means of the valve terminal and the bypass line is interrupted, so that the built-up dynamic pressure via the direct print head leads to an increased output of the printing ink. This cleans the direct print head most effectively. The supply valve and the return valve can be arranged in the supply line or the return line. Optionally, the supply valve can be connected to the supply port and the return valve to the return port of the direct print head, in particular, directly via ink lines.

Between the valve terminal and the direct print head, at least one quick coupling can be provided to selectively connect or disconnect the direct print head from the ink supply system. This allows the direct print head to be changed particularly easily and quickly. In addition, when changing the direct print head, it is possible to interrupt the ink flow via the valve terminal and make it parallel to the direct print head via the bypass line, so that the ink flow is not hindered by changing the direct print head. Optionally, the at least one quick coupling can be arranged in the supply line and/or return line. In particular, one quick coupling can each be assigned to the supply port or the return port of the direct print head.

A supply pressure sensor can be arranged between the valve terminal and the direct print head in the supply line, and optionally a return pressure sensor in the return line to detect the meniscus pressure. This allows the meniscus pressure to be detected by the aforementioned control unit, and the pressure in the at least one header tank to be controlled. As a result, the meniscus pressure is set particularly precisely. Consequently, the meniscus pressure is set very accurately. Optionally, the supply pressure sensor and/or the return pressure sensor can be arranged directly upstream or downstream of the direct print head in the supply or return line. This makes the measurement of meniscus pressure very accurate.

The supply pressure sensor and optionally the return pressure sensor can be arranged between the respective quick coupling and the direct print head. As a result, the measurement of the meniscus pressure remains unaffected by pressure drops in the quick couplings and is therefore particularly accurate.

Between the valve terminal and the direct print head, a supply filter can be arranged in the supply line, and optionally a return filter for the printing ink in the return line to protect the print head from particles in the printing ink.

Optionally, the supply filter and optionally the return filter can be arranged between the respective quick coupling and the direct print head. Thereby, the particles are filtered out of the printing ink, which penetrate, for example, when opening and closing the quick couplings, such that they cannot get caught in the fine print nozzles of the direct print head.

The direct print head, the valve terminal and the at least one header tank can be designed to be movable with a joint adjustment unit. As a result, the height between the header tank and the direct print head does not change due to an adjustment, such that the meniscus pressure is kept constant regardless of the movement of the direct print head. With the adjustment unit, it is possible to adjust the position of the direct print head in relation to the containers, for example, when changing to another container type. The adjustment unit can include a linear motor to move the direct print head, the valve terminal and the at least one header tank optionally vertically.

An exchangeable maintenance unit with an ink filter and a degassing cartridge can be arranged in the supply line between the supply tank and the valve terminal, which is designed to be interchangeable, in particular by means of the quick couplings. In this way, particles, dissolved gases and gas bubbles in the printing ink are filtered out, such that they are not conveyed to the direct print head via the ink supply system. The quick couplings make it possible to replace the maintenance unit particularly quickly. This results in particularly low maintenance costs.

A pneumatic unit can be designated to the at least one header tank to regulate the pressure of an air cushion in the at least one header tank, the pneumatic unit optionally comprising a piezo proportional valve. With the pressure of the air cushion in the at least one header tank, the meniscus pressure and circulation can be regulated independently of the discharge pressure of the ink pump. Optionally, the supply tank is connected to the header tank by means of ink lines via the ink pump in the supply line, the maintenance unit and/or the distribution unit, such that printing ink can be fed continuously or intermittently into the header tank. The pneumatic unit can include a proportional valve for an overpressure supply and/or a proportional valve for a vacuum supply to regulate the pressure of the air cushion in the header tank. Optionally, the pneumatic unit can include a collecting unit for returning printing ink from the direct print head. This protects the pneumatic unit very well against the suction of printing ink from the at least one header tank in the event of a vacuum caused by a malfunction.

The supply tank can include an agitator to prevent sedimentation of the printing ink. This ensures that the liquid and particle-like elements of the printing ink are continuously mixed in the supply tank, ensuring a constant consistency of the printing ink.

In addition, in order to solve the problem, the present disclosure provides for a direct printing process for printing containers with direct printing, the containers being conveyed by a conveyor past at least one stationary direct printing station, the containers being printed with the direct printing at the at least one stationary direct printing station by a direct print head, wherein the direct print head is supplied with printing ink by an ink supply system from a supply tank, wherein an ink flow from the supply tank to the direct print head and/or back is produced via a supply line and/or a return line of the ink supply system, wherein a meniscus pressure of the printing ink towards the direct print head is adjusted with at least one header tank arranged in the supply line and/or the return line, and wherein the ink flow via the direct print head is interrupted by a valve terminal arranged in the supply line and/or in the return line between the at least one header tank and the direct print head, and is produced instead in a bypass line parallel to the direct print head.

By adjusting the meniscus pressure of the printing ink towards the direct print head with the at least one header tank arranged in the supply line and/or return line, it can be adjusted so that the printing result is of particularly high quality without using an additional ink pump.

By interrupting the ink flow through the direct print head with the valve terminal and creating a bypass line parallel to the direct print head, it is possible to automatically rinse the ink supply system with printing ink during maintenance or startup, and remove bubbles or foreign matter from it. In addition, it is possible to open the valves in the valve terminal intermittently and thus carry out the purge (shock cleaning) with increased pressure. This makes the direct print head particularly easy to clean independently of other direct print heads connected to the ink supply system. For example, the air and/or air bubbles can be removed from the pressure system.

Consequently, with the direct printing method according to the present disclosure, it is possible to achieve a high quality of direct printing at lower ink supply cost.

Optionally the ink flow can be produced via the direct print head with the valve terminal arranged between the at least one header tank and the direct print head, and therefore the ink flow in the bypass line can be interrupted parallel to the direct print head. This allows the direct print head to print again in a normal printing operation.

In addition, the direct printing method can comprise the features described above with respect to the direct printing machine. The direct printing process can be carried out with the direct printing machine described above.

### BRIEF DESCRIPTION OF FIGURES

Further features and advantages of the present disclosure are explained in more detail below with reference to embodiments described in the figures.

FIG. 1 shows an inventive embodiment of a direct printing machine for printing containers with direct printing in an overview from above.

FIG. 2 shows the ink supply system of FIG. 1 as a circulating variant in a diagram view.

FIG. 3 shows another version of the ink supply system of FIG. 1 as a non-circulating variant in a diagram view.

### DETAILED DESCRIPTION

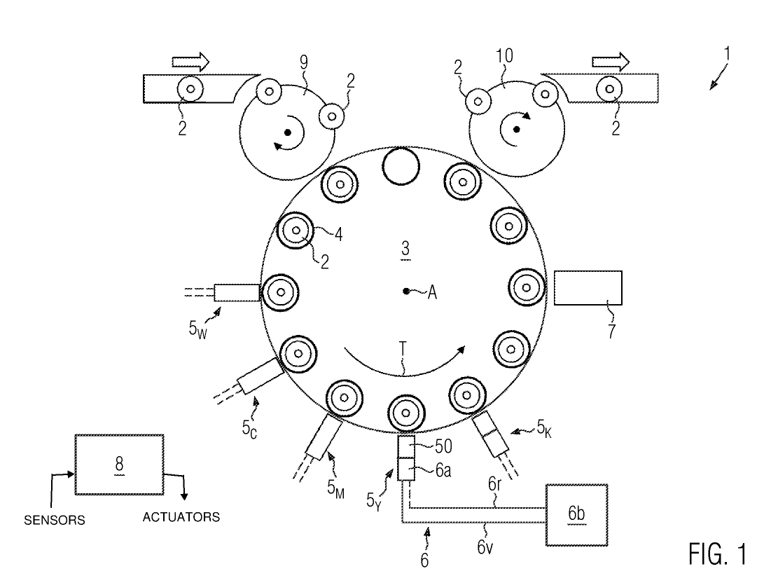

FIG. 1 shows in an overview an inventive embodiment of a direct printing machine 1 for printing containers 2 with direct printing. It can be seen that container 2, for example, coming from a filler and a capper, is fed to the conveyor 3 with the infeed starwheel 9.

The container receptacles 4 are arranged on conveyor 3, which are shown here only schematically. The container receptacles 4 can comprise, for example, a rotary plate and a centring bell to accommodate the container bottom or the mouth area of the respective container 2. The conveyor 3, for example, is designed as a carousel and rotates about the axis A, so that the containers 2 in the container receptacles 4 are conveyed in the transport direction T at the stationary direct printing stations 5_{W}, 5_{C}, 5_{M}, 5_{Y}, 5_{K}.

The stationary direct printing stations 5_{W}, 5_{C}, 5_{M}, 5_{Y}, 5_{K}, each comprising three direct print heads 50, are arranged around the conveyor 3. However, it is also conceivable that the stationary direct printing stations 5_{W}, 5_{C}, 5_{M}, 5_{Y}, 5_{K} each comprise only one, two or more than three direct print heads 50. The stationary direct printing stations 5_{W}, 5_{C}, 5_{M}, 5_{Y}, 5_{K} are designed for printing with printing inks of different colors, according to the reference characters 5_{W}, 5_{C}, 5_{M}, 5_{Y}, 5_{K} with white, cyan, magenta, yellow and black. Thus, a multicolored direct print can be printed on the containers 2. The printing inks are optionally UV-curing to enable a fast drying process.

Furthermore, conveyor 3 is designed for intermittent conveyance of containers 2, whereby the container receptacles 4 are each stopped at pressure positions opposite the stationary direct pressure stations 5_{W}, 5_{C}, 5_{M}, 5_{Y}, 5_{K}. During printing, the containers 2 are rotated around their longitudinal axes by means of the container receptacles 4 and printed by the direct print heads 50, according to the ink jet principle. It is also conceivable that the conveyor 3 is designed for continuous conveyance of the containers 2, especially when printing on shaped or molded containers. The containers 2 with the container receptacles 4 are pivoted at an angle relative to the direct print heads 50, such that the pressure interval varies in as small a range as possible.

Each of the direct print heads 50 have at least one nozzle row with a plurality of nozzles, for example 1,000 nozzles, which are controlled by the control unit 8 in such a way that individual ink droplets are supplied to the containers 2. The at least one row of nozzles is aligned essentially parallel to the container axes, so that a flat direct pressure is generated by the rotation by means of the container receptacles 4.

After the direct printing is applied, the containers 2 are driven past the curing station 7 by means of the conveyor 3, and the printing ink is cured by means of UV light. It is also conceivable that additional pinning stations are arranged between the individual stationary direct printing stations 5_{W}, 5_{C}, 5_{M}, 5_{Y}, 5_{K} in order to fix the individual colors.

The containers 2 are subsequently conveyed by the conveyor 3 to the discharge starwheel 10 and fed to further processing stations, for example, a packaging machine.

Using the print head 5_{Y} in FIG. 1 as an example, it can be seen that direct printing machine 1 comprises ink supply system 6 for supplying direct print heads 50 with ink from a supply tank. It goes without saying that a corresponding ink supply system is also connected to the stationary direct printing stations 5_{W}, 5_{C}, 5_{M}, 5_{K}.

The ink supply system 6 consists of a part 6a directly connected to the direct print heads 50 and a second part 6b with the supply tank. The two parts 6a, 6b are connected by sections of supply line 6v and return line 6r.

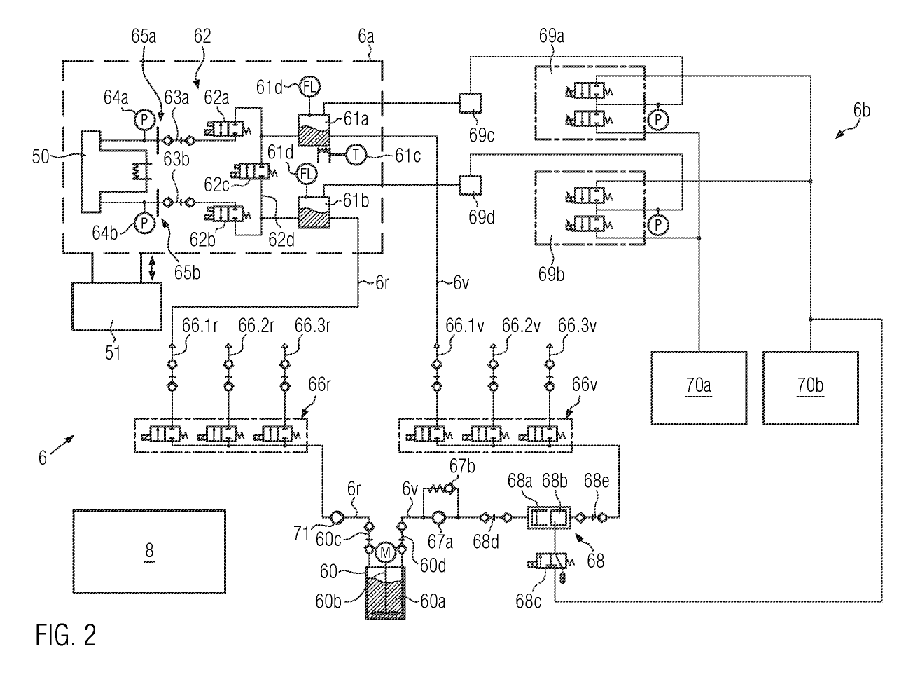

Also visible is control unit 8, which controls the direct printing machine 1, in particular, conveyor 3, container receptacles 4, stationary direct printing stations 5_{W}, 5_{C}, 5_{M}, 5_{Y}, 5_{K}, ink supply system 6, evaluation unit 7, infeed starwheel 9 and discharge starwheel 10. The control unit 8 is shown as a microprocessor with non-transitory memory storing instructions which controls the direct print machine 1. The control unit 8 is shown receiving various signals from sensors coupled to the direct printing machine 1, and transmitting instructions to various actuators. The sensors may include pressure sensors 64a, 64b, for example. The sensors may include level sensors 61d, for example. The actuators may include valves 62a, 62b, 62c, for example. The actuators may include pneumatic units 69a, 69b, for example. (See FIG. 2).

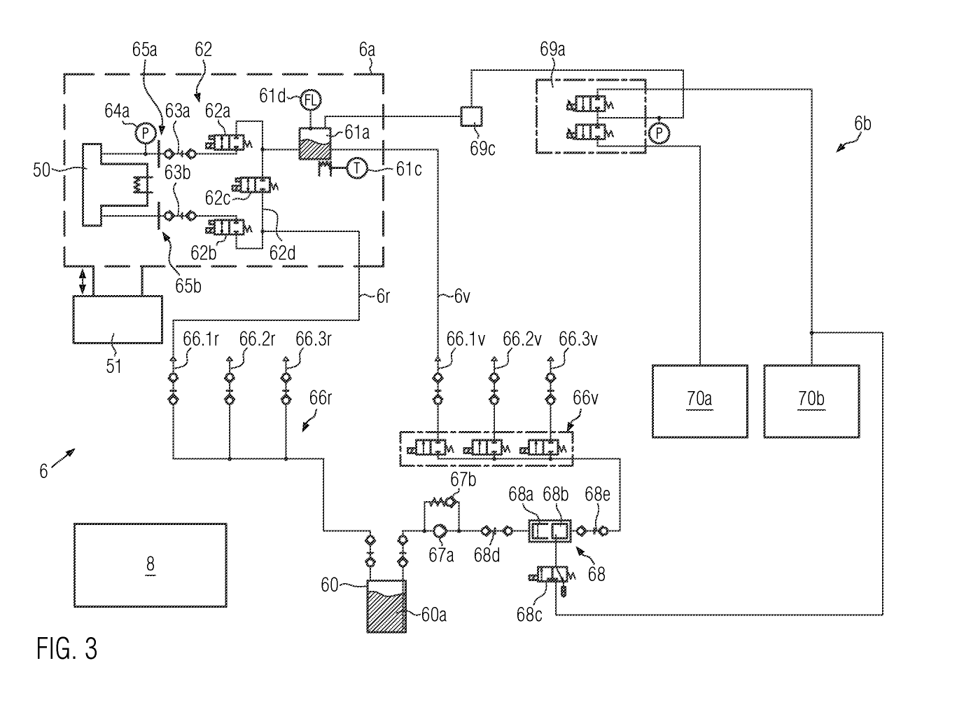

The ink supply system 6 is explained in more detail below using the variants shown in FIGS. 2 and 3:

FIG. 2 shows a circulating version of the ink supply system 6 from FIG. 1 as a diagram view. The ink supply system 6 is designed to supply the direct print heads 50 of FIG. 1 with ink 60a from the supply tank 60. For the sake of clarity, FIG. 2 shows only one single supply line from the 66v and 66r distribution units to one of the direct print heads 50. It goes without saying that two corresponding supply lines with the two remaining direct print heads 50 are attached to the distribution units 66v, 66r. In addition, the 66v and 66r distribution units can also be designed to distribute the printing ink to only two or more than three of the direct print heads 50.

The supply tank 60, in which there is a supply of printing ink 60a, can be seen. The supply is constantly stirred with the agitator 60b to mix in ink 60a flowing back from the return line 6r to ensure a high degree of homogeneity. In addition, this generally prevents pigments settling from the printing ink 60a. The ink is removed from the supply tank 60 via the 6v feed line and conveyed to the direct print heads 50 via the 67a feed line ink pump. Parallel to the flow ink pump 67a, there is a pressure relief valve 67b to absorb pressure peaks.

Following the supply ink pump 67a, the exchangeable maintenance unit 68 with the ink filter 68a and the degassing cartridge 68b, which can be separated from the ink flow and replaced using the quick couplings 68d, 68e, is located in the 6v supply line. The ink filter 68a removes particles and the degassing cartridge 68b removes bubbles and/or dissolved gases from the printing ink 60a. The degassing cartridge 68b is connected to the vacuum supply 70b via the valve 68c to remove the bubbles. The valve 68c may be only opened when the supply ink pump 67a delivers the printing ink 60a. This ensures that the ink 60a is degassed evenly.

Subsequently, the printing ink is distributed via the first 66v distribution unit to the direct print heads 50, which are each supplied with printing ink via the 66.1v, 66.2v and 66.3v connections. For this purpose, one switching valve per 66.1v, 66.2v, 66.3v connection is provided to control the ink flow.

After the distribution unit 66v, the printing ink with the supply line 6v is fed via the supply header tank 61a, the valve terminal 62 to the direct print head 50 and from there with the return line 6r back via the valve terminal 62, the return header tank 61b to the second distribution unit 66r.

With the second distribution unit 66r in the return line 6r, the backflowing ink is again recombined by the individual direct print heads 50 from the connections 66.1r, 66.2r or 66.3r and optionally fed back into the supply tank 60 via the return line ink pump 71. Here as well, a switching valve is provided for each port 66.1r, 66.2r, 66.3r to control the ink flow.

The supply header tank 61a and the return header tank 61b are used to set the meniscus pressure and the circulation of the ink 60a through the direct print head 50. The first pneumatic unit 69a is assigned to the supply header tank 61a and the second pneumatic unit 69b is assigned to the return header tank 61b. They each include a pressure sensor to regulate the pressure with two proportional valves from a compressed air supply 70a or a vacuum supply 70b, such that an air cushion with the desired pressure is created in the respective header tank 61a, 61b. Consequently, a pressure gradient is generated between the supply head tank 61a and the return head tank 61b, thereby allowing circulation to be controlled by the direct print head 50. The meniscus pressure results from the mean value of the pressures in the supply and return header tank 61a, 61b. This means that the direct print is printed with very high quality.

In addition, the level sensors 61d are arranged on the supply header tank 61a and the return headertank 61b, via which the levels are detected and controlled on this basis.

Furthermore, the supply header tank 61a also includes a heat unit 61c that brings the printing ink to the desired temperature for optimal direct printing.

Furthermore, it can be seen that between the pneumatic units 69a, 69b and the two header tanks 61a, 61b, there are respective receiving units 69c, 69d for entrained printing ink. This protects the pneumatic units 69a, 69b and the vacuum supply 70b from entrained printing ink in the event of a fault.

It can also be seen that the valve terminal 62 is arranged between the two header tanks 61a, 61b and the direct print head 50 in the supply line 6v and in the return lines 6r. For this purpose, valve terminal 62 comprises a switchable supply valve 62a in supply line 6v, a switchable return valve 62b in return line 6r and a switchable bypass valve 62c in bypass line 62d.

It can also be seen that a quick coupling 63a, 63b is arranged between valve terminal 62 and direct print head 50 in supply line 6v and return line 6r, respectively, in order to connect or disconnect the direct print head optionally to the ink supply system 6.

With the valve terminal 62 and the quick couplings 63a, 63b it is possible to interrupt the ink flow via the direct print head 50 and to produce it in the bypass line 62d parallel to the direct print head 50. As a result, the ink no longer flows over the direct print head 50, but rather over the bypass line 62d. At the same time, the quick couplings 63a, 63b can be released and the direct print head 50 can be replaced for maintenance or replacement.

Conversely, after starting up the new or maintained direct print head 50, the bypass valve 62c is closed again and the supply valve 62a and the return valve 62b are opened again to create the ink flow via the direct print head 50.

It is also possible with valve terminal 62 to interrupt the ink flow to the print head when the direct press 1 is at a standstill in order to use the time for rinsing the ink supply system 6.

As a result, it is possible to automatically rinse the ink supply system 6 with printing ink and remove any bubbles or foreign matter during maintenance, start-up or when the direct printing machine 1 is at a standstill. This results in a particularly high print quality.

Furthermore, the valve terminal 62 can be used to interrupt the ink flow via the direct print head 50 for pressure build-up through the header tanks 61a, 61b, so that subsequently a highly effective purging of the print nozzles in the direct print head 50 under increased pressure can occur.

It can also be seen that the supply pressure sensor 64a is arranged between valve terminal 62 and the direct print head 50 in the supply line 6v and the return pressure sensor 64b in the return line 64. As a result, the pressure conditions are detected via the direct print head 50, and thus the meniscus pressure can be detected and adjusted very precisely. Since the two pressure sensors 64a, 64b are also arranged between the quick coupling 63a, 63b and the direct print head 50, pressure losses through the quick couplings 63a, 63b cannot falsify the measuring result.

Furthermore, a supply filter 65a can be arranged between valve terminal 62 and direct print head 50 in the supply line 6v and a return filter 65b for the print ink 60a in the return line 6r to protect the print head 50 from particles in the print ink 60a. These are arranged, for example, between the respective quick coupling 63a, 63b and the direct print head 50.

Furthermore, it can be seen that part 6a of the ink supply system 6 attached to the direct print head 50 comprises the two header tanks 61a, 61b, the valve terminal 62, the quick couplings 63a, 63b, the supply filter 65a, the return filter 65b, the supply pressure sensor 64a and the return pressure sensor 64b, and that part 6a is designed to be movable together with the adjustment unit 51. This does not change the liquid level in the header tanks 61a, 61b, when compared to the direct print head 50, such the pressure ratios are not changed by the method of direct print head 50.

The circulating variant of ink supply 6 is particularly suitable for the use of white printing inks with higher pigmentation, which otherwise tend to settle.

FIG. 3 shows another variant of the ink supply system 6 of FIG. 1 as a non-circulating variant in a diagram view. This has all the features previously described in FIG. 2, but without the agitator, the return ink pump, the switching valves in the second distribution unit 66r, the return header tank and the return pressure sensor on the direct print head 50.

All other features apply accordingly. This makes ink supply 6 even easier to set up and is particularly suitable for use with colored printing inks having lower pigmentation. In contrast to the previous design example in FIG. 2, the return 6r remains unused during regular printing operation. This only supports filling the ink supply system 6 with the printing ink 60a during startup. It is also conceivable that the ink supply system 6 will be emptied via the return line 6r.

The direct printing machine 1 described in FIGS. 1 to 3 and the ink supply system 6 are used in regular printing operation as follows:

The containers 2 are conveyed by conveyor 3 to the stationary direct printing stations 5_{W}, 5_{C}, 5_{M}, 5_{Y}, 5_{K}, where the containers 2 are printed by three direct print heads 50 at the stationary direct printing stations 5_{W}, 5_{C}, 5_{M}, 5_{Y}, 5_{K} with a direct print.

The ink supply system 6 supplies the direct print heads 50 of a color with ink 60a from the supply tank 60, whereby an ink flow from the supply tank 60 to the direct print head 50 is produced via the supply line 6v of the ink supply system 6. In addition, in the embodiment shown in FIG. 2, an ink flow from the direct print head 50 back to the supply tank 60 is produced in regular printing operation via the return line 6r.

The meniscus pressure of the printing ink 60a to the direct print head 50 with the header tanks 61a, 61b, which is arranged in the supply line and optionally in the return line 6v, 6r, is set in such a way that a particularly high print quality is achieved.

In addition, ink flow through direct printhead 50 can be interrupted during start-up, maintenance, downtime and printhead replacement with valve terminal 62 located in the supply and return lines 6v, 6r between the header tanks 61a, 61b and the direct printhead 50, and produced in bypass line 62d parallel to the direct printhead 50.

Thereby, the ink supply system 60 can be rinsed while the direct print head 50 is replaced with as little ink loss as possible.

Furthermore, it is possible to interrupt the ink flow over the direct print head 50 by means of valve terminal 62 in order to build up the pressure of the printing ink 60a with the two header tanks 61a, 61b for a subsequent purge.

It goes without saying that the features mentioned in the embodiments described above are not limited to these combinations, but can also be used individually or in any other combinations.

1. A direct printing machine for printing containers with direct printing, with at least one stationary direct printing station with a direct print head for printing the containers with the direct printing, an ink supply system for supplying the direct print head with printing ink from a supply tank, and with a conveyor for conveyance of the containers past the at least one stationary direct printing station, the ink supply system comprising a supply line and/or a return line for the printing ink to produce an ink flow from the supply tank to the direct print head and/or back, wherein the ink supply system comprises at least one header tank arranged in the supply line and/or return line for setting a meniscus pressure of the printing ink towards the direct print head, and in that a valve terminal is arranged between the at least one header tank and the direct print head in order to interrupt the ink flow via the direct print head and to produce it in a bypass line parallel to the direct print head.

2. The direct printing machine according to claim 1, wherein the valve terminal comprises a switchable supply valve in the supply line and/or a switchable return valve in the return line and/or a switchable bypass valve in the bypass line.

3. The direct printing machine according to claim 1, wherein at least one quick coupling is disposed between the valve terminal and the direct print head for selectively connecting or disconnecting the direct print head to the ink supply system.

4. The direct printing machine according to claim 1, wherein a supply pressure sensor is arranged between the valve terminal and the direct print head in the supply line in order to detect the meniscus pressure.

5. The direct printing machine according to claim 3, wherein the supply pressure sensor is arranged between the respective quick coupling and the direct print head.

6. The direct printing machine according to claim 1, wherein a supply filter is arranged between the valve terminal and the direct print head in the supply line and/or in the return line a return filter for the printing ink to protect the print head from particles in the printing ink.

7. The direct printing machine according to claim 6, wherein at least one quick coupling is disposed between the valve terminal and the direct print head for selectively connecting or disconnecting the direct print head to the ink supply system, and wherein the supply filter and the return filter are arranged between the respective quick coupling and the direct print head.

8. The direct printing machine according to claim 1, wherein the direct print head, the valve terminal and the at least one header tank are movable with a joint adjustment unit.

9. The direct printing machine according to claim 1, wherein an exchangeable maintenance unit with an ink filter and a degassing cartridge is arranged in the supply between the supply tank and the valve terminal and is designed to be exchangeable.

10. The direct printing machine according to claim 1, wherein a pneumatic unit is associated with the at least one header tank for regulating pressure of an air poster in the at least one header tank.

11. The direct printing machine according to claim 1, wherein the supply tank comprises an agitator for preventing sedimentation of the printing ink.

12. The direct printing machine according to claim 1, wherein the at least one stationary direct printing station comprises at least one further direct print head with at least one further valve terminal and with at least one further header tank, and wherein a distribution unit is arranged after the supply tank to distribute the printing ink to the direct print head and the at least one further direct print head.

13. A direct printing method for printing containers with direct printing, the containers being conveyed by a conveyor past at least one stationary direct printing station, the containers being printed with the direct printing at the at least one stationary direct printing station by a direct print head, wherein the direct print head is supplied with printing ink by an ink supply system from a supply tank, wherein an ink flow from the supply tank to the direct print head and/or back is produced via a supply line and/or a return line of the ink supply system, wherein a meniscus pressure of the printing ink towards the direct print head is adjusted with at least one header tank arranged in the supply line and/or the return line, and wherein the ink flow via the direct print head is interrupted by a valve terminal arranged in the supply line and/or in the return line between the at least one header tank and the direct print head, and is produced instead in a bypass line parallel to the direct print head.

14. The direct printing machine according to claim 4, wherein a return pressure sensor is arranged in the return line in order to detect the meniscus pressure.

15. The direct printing machine according to claim 5, wherein the return pressure sensor is arranged between the respective quick coupling and the direct print head.

16. The direct printing machine according to claim 9, wherein the exchangeable maintenance unit is exchangeable by means of quick couplings.

17. The direct printing machine according to claim 10, wherein the pneumatic unit comprises a piezo proportional valve.
